(19) United States
(12) Patent Application Publication
(10) Pub. No.: US 2016/0187511 A1
(43) Pub. Date: Jun. 30, 2016

(54) PULSED MARINE SOURCE

(71) Applicant: CONOCOPHILLIPS COMPANY, Houston, TX (US)

(72) Inventors: Peter M. EICK, Houston, TX (US); Joel D. BREWER, Houston, TX (US); Frank D. JANISZEWSKI, Houston, TX (US)

(21) Appl. No.: 14/868,895

(22) Filed: Sep. 29, 2015

Related U.S. Application Data
(60) Provisional application No. 62/058,894, filed on Oct. 2, 2014.

(51) Int. Cl. G01V 1/36; G01V 1/38

(52) U.S. Cl. CPC G01V 1/36; G01V 1/3808; G01V 1/3861

(57) ABSTRACT

Systems and methods for generating seismic signal include using a conventional airgun array and specifically detunes the timing of the array so individual airguns are not fired at the same time and with their interacting bubbles form a unique composite pulse that can be separated by various means out of a seismic record to form the shotpoint. The advantage of this approach is a lower overall noise envelope in the water minimizing impact on the marine mammals and it allows multiple arrays to be fired in close spatial and timing proximity with minimal to no interference.

### CROSS-REFERENCE TO RELATED APPLICATIONS

This application is a non-provisional application which claims benefit under 35 USC §119(e) to U.S. Provisional Application Ser. No. 62/058894 filed Oct. 2, 2014, entitled “PULSED MARINE SOURCE,” which is incorporated herein in its entirety

### FIELD OF THE INVENTION

This invention relates to systems and methods for generating seismic signals during marine acquisition and, more particularly, to generating sweep signals during seismic acquisition.

### BACKGROUND OF THE INVENTION

Seismic reflection surveying involves sending seismic waves into a subterranean formation, measuring reflected signals, and processing collected data to image subsurface regions. The seismic waves (seismic signals) are generated by seismic sources that can be categorized as impulsive or non-impulsive. Examples of seismic sources include, but are not limited to, dynamite, air gun, weight dropper, and vibrator. Impulsive seismic sources such as air gun, dynamite, and weight dropper are normally used to generate seismic impulse signals. Non-impulsive sources such as a vibrator are normally used to generate seismic sweep signals. Impulse-generating sources provide near instantaneous seismic energy while non-impulsive sources propagate energy into the ground for an extended period of time.

Vibroseis is a well-known technique that generates sweep signals using truck-mounted seismic vibrators. Unlike impulsive seismic sources that produce a single pulse of seismic energy, vibroseis can generate a “wave train” over a period of several seconds. Vibrators work on a principle of introducing a specified band of frequencies (“sweep”) and cross-correlating the sweep function with recorded data to define reflection events. The wave train can include sweep of frequencies varying from less than about 10 Hz to greater than about 100 Hz. Vibratory input usually begins at a relatively low frequency, then sweeps up to a higher frequency over the course of several seconds to avoid ghost issues that can result from the cross-correlation process. One benefit of vibroseis that vibratory acquisition is typically less damaging to the environment than impulsive sources. Impact on vegetation and marine life are minimal and long-lasting disturbances to soil are rare.

Choosing a seismic source can depend on a number of factor including whether the seismic survey is being done on-land or off-shore. For example, while air gun can be used for both land and marine acquisitions, it is a main source for marine seismic acquisition. Modern seismic vessels typically tow multiple arrays of air guns, each array sometimes having 10 or more air guns. Air guns inject high-pressure air into the water during marine seismic acquisition creating an impulsive response. One potential problem with impulsive sources is that firing the air guns at once creates a loud sound that can impact aquatic life. Another problem is that the seismic sources generate sound that is non-unique, thus preventing efficient gathering of seismic data since multiple sets of seismic sources cannot be fired at the same time without significant cross-talk.

### SUMMARY OF THE INVENTION

This invention relates to systems and methods for generating seismic signals during marine acquisition and, more particularly, to generating sweep signals during seismic acquisition.

One example of a method for acquiring seismic data comprising: initiating firing of individual seismic sources at start of a shot point, wherein two or more of the plurality of seismic sources fire asynchronously in a selected sequence to generate a coded seismic signal; collecting seismic data from the coded seismic signal; inverting the seismic data; and generating an output trace via computing device using the inverted seismic data.

Another example a method for acquiring seismic data comprising: arranging a plurality of seismic sources into an array of seismic sources; firing the array of seismic sources, wherein at least two or more seismic sources are fired asynchronously in a selected sequence to generate a coded seismic signal; collecting seismic data from the coded seismic signal using a plurality of seismic receivers; inverting the seismic data; and generating an output trace using the inverted seismic data.

Another example of a method for acquiring seismic data comprising: arranging a plurality of seismic sources into an array of seismic sources; initiating firing of the array of seismic sources, wherein at least two or more seismic sources are fired asynchronously in a selected sequence to generate a pulse signal; collecting seismic data using a plurality of seismic receivers; inverting the seismic data; and generating an output trace using the inverted seismic data.

### BRIEF DESCRIPTION OF THE DRAWINGS

The invention, together with further advantages thereof, may best be understood by reference to the following description taken in conjunction with the accompanying figures by way of example and not by way of limitation, in which:

FIG. 1 is a schematic top view of a tow vessel towing two seismic source arrays and streamers for acquiring seismic data in a marine environment.

FIG. 2 is a schematic top view of an example source array of air guns.

FIG. 3 is a schematic top view of a tow vessel towing two seismic source arrays and streamers where the streamers are flared.

FIG. 4 illustrates an embodiment of the invention as described in the Example.

FIG. 5 illustrates an embodiment of the invention as described in the Example.

FIG. 6 illustrates an embodiment of the invention as described in the Example.

FIG. 7 illustrates an embodiment of the invention as described in the Example.

FIG. 8 illustrates an embodiment of the invention as described in the Example.

FIG. 9 illustrates an embodiment of the invention as described in the Example.

FIG. 10 illustrates an embodiment of the invention as described in the Example.

FIG. 11 illustrates an embodiment of the invention as described in the Example.

FIG. 12 illustrates an embodiment of the invention as described in the Example.

FIG. 13 illustrates an embodiment of the invention as described in the Example.

FIG. 14 illustrates an embodiment of the invention as described in the Example.

FIG. 15 illustrates an embodiment of the invention as described in the Example.

FIG. 16 illustrates an embodiment of the invention as described in the Example.

FIG. 17 illustrates an embodiment of the invention as described in the Example.

### DETAILED DESCRIPTION OF THE INVENTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variation can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the appended claims and their equivalents.

The present invention provides tools and methods for generating sweep signals using impulsive seismic sources during seismic acquisition. This can be accomplished by utilizing an array of impulsive sources (e.g., air guns or similar sources like plasma shots or explosive shots) to create a sweep signal during marine seismic acquisition. Utilizing impulsive sources that generate sweep signals can provide several advantages or benefits over conventional methods. For example, disturbances to vegetation and marine life can be reduced. Impulsive sources also tend to be more robust and cost-effective compared to non-impulsive sources. Other advantages will be apparent from the disclosure herein.

As eluded to earlier, an array of air guns is often used to general seismic signals for marine seismic acquisition. In such a setup, air guns are tuned to produce a short, sharp pulse. This is performed by selecting air guns of varying sizes, placing the air guns in a specific layout or an array, and firing them all at the same time (typically within 1 millisecond of each other).

The present invention provides a swept source signature that is generated from asynchronous firing (“detuned”) impulse seismic sources (e.g., air guns) arranged in an array. This combines the advantages of using impulse seismic sources such as air guns (e.g., air guns tend to be reliable, robust, and efficient) with the advantages of using a swept source (e.g., less invasive signal, operationally efficient and with many bubble effects). Simultaneous acquisition of multiple marine seismic sources is achieved because each string has a unique spacing and pulse width. In one embodiment, the present invention provides a plurality of marine seismic impulse sources (e.g., air guns), wherein the seismic impulse sources are intentionally detuned to create a unique pulse. Examples of air guns or array of air guns are described in U.S. Pat. No. 3,187,831, U.S. Pat. No. 4,713,800 and U.S. Pat. No. 3,379,273, the relevant parts of which are hereby incorporated by reference.

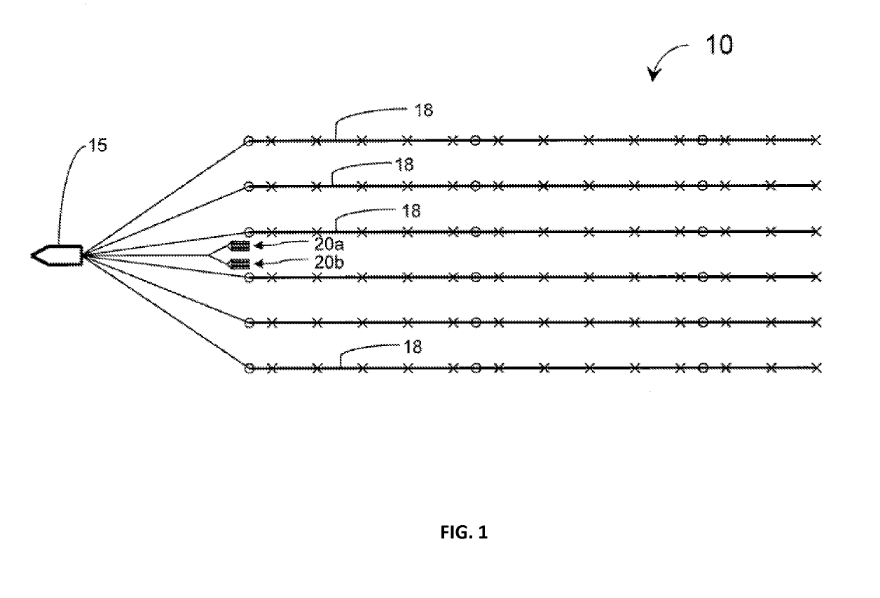

FIG. 1 shows a seismic acquisition system 10. The system 10 includes a tow vessel 15 towing a number of streamers 18. Along each streamer 18 are a large number of seismic receivers, not specifically indicated. The seismic sources are also towed behind tow vessel 15 in the form of two source gun arrays, 20a and 20b. It is common to use air guns in marine seismic acquisition and for each source gun array to comprise a number of air guns where all the air guns are fired in unison or at once to create a sufficiently powerful impulse to create a return wavefield that is perceptible by the seismic receivers along the streamers 18. It is also common to tow two sets of source gun arrays forming the port and starboard gun array set.

Some conventional seismic acquisitions require that all guns arranged in arrays to be fired at once (synchronous). The common timing spec is that all guns must fire within 1 ms of each other. If all the guns don't fire within the 1 ms window, then the array must be recovered and repaired until it meets the required specification. Normally, a source gun array will be formed of 2 to 3 sub arrays, and each sub array will be made up of around 10 individual air guns of varying sizes. In normal operation, all guns (20 or 30) will be fired almost simultaneously to try and create a single, sharp peak of energy. The varied sizes of the guns provide a large composite peak of energy with little or no reverberation by firing simultaneously and creating air bubbles that cancel each other out so that the large composite peak will propagate through the sea and into the seafloor. By conventional standards this is the optimal way of sourcing marine seismic data.

In the present invention, the guns are not fired in unison, but rather in a series of pulses that are arranged into one or more composite pulses that are unique or at least distinctive and can be distinguished in the return wavefield from other seismic energy in the environment and also distinguished from other composite pulses. The composite pulses result in rumbles instead of the traditional crack of the guns firing in unison so that there is no large composite peak at the start of the source event. The present invention further includes the delivery of pulses in the form of a loop of distinctive composite pulses where not only is the loop distinctive, but the composite pulses within the loop are distinctive one from another. The loop is of sufficient length in time to permit recording of the returning wavefield before the end of the loop is reached and restarted. In practice, the loop will be delivered continuously or nearly continuously to obtain significant volumes of seismic data at conventional boat speeds. Since the pulses are delivered in distinctive sequences, several spaced apart sources may be deployed to create and gather seismic data from a variety of angles concurrently. As such, the pulse type sources, typically air guns, may be arranged in a number of arrays with each array delivering its own loop of pulses of seismic energy in a synchronized or non-synchronized manner that is source separable in the data traces of the recorded return wavefield.

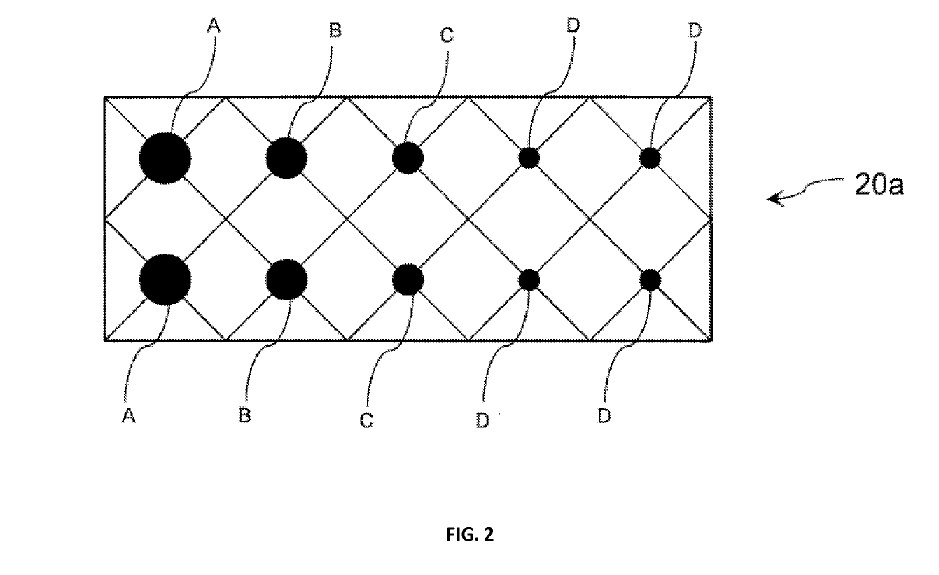

As shown in FIG. 1, the simplified and diagrammatic source arrays are generally indicated by the arrow 20a and 20b comprising two side by side arrays. A close-up of source gun array 20a is shown in FIG. 2. As illustrated in FIG. 2, the source gun array 20a is shown with ten individual air guns of varying sizes. The largest guns are labeled A. The large guns are labeled B. The medium guns are labeled C and the small guns are labeled D. The largest air guns A provide very low frequency seismic energy, the two large air guns B generate low frequency energy, the two medium air guns C provide more mid frequency seismic energy and the four small air guns D provide higher frequency seismic energy. Normally, an array can comprise many more air guns and more air guns of different sizes. It is also possible to have more small air guns than large air guns to make up for the lower amount of energy that released by one pulse of each smaller air gun. This is all part of the traditional tuning of the source to give the sharpest, cleanest peak with the minimal bubble effects. It is also possible to put the largest guns first for ease of deployment and stable towing conditions through the water. These are not necessarily requirements.

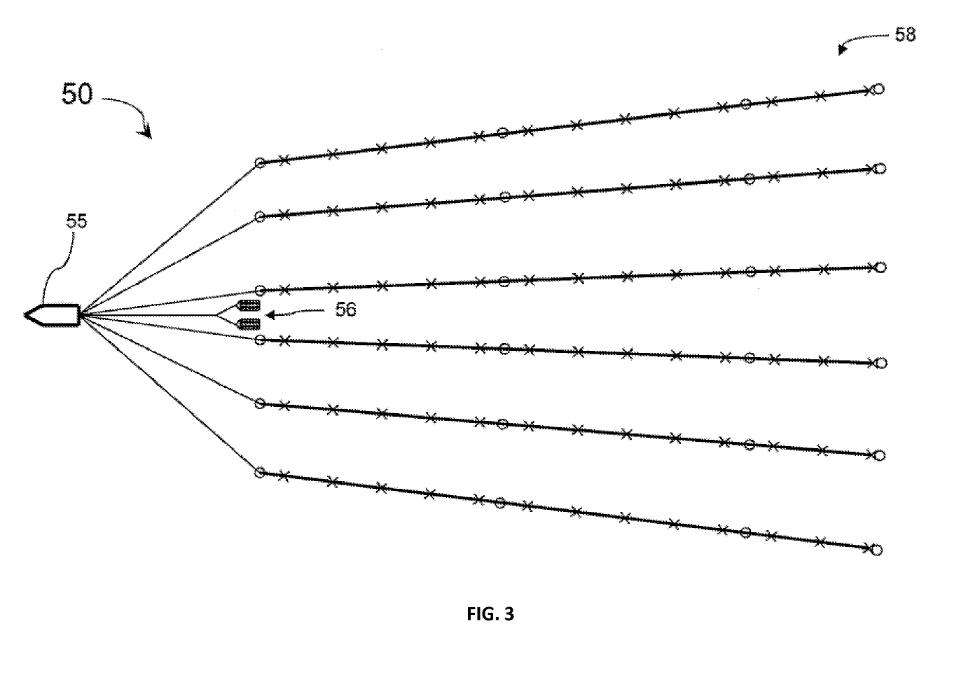

Turning now to FIG. 3, a marine seismic acquisition system 50 with a flared receiver array 58 is shown that is comparable to system 10 in FIG. 1. The flared receiver array 58 reduces risk of gaps of coverage in both the near receivers (closest to the tow vessel 55) and far receivers (farthest from the tow vessel 55). Side by side dual source arrays 56 are shown between the middle two streamers of receiver array 58 representing conventional flip flop shooting style acquisition.

Some embodiments of the invention provide a method for acquiring seismic data comprising the steps of: initiating firing of individual seismic sources at start of a shot point, wherein two or more of the plurality of seismic sources fire asynchronously in a selected sequence to generate a coded seismic signal; collecting seismic data from the coded seismic signal; inverting the seismic data; and generating an output trace via computing device using the inverted seismic data. As used herein, the term “asynchronously” refers to the firing of two or more seismic sources, wherein the time period between shots is greater than about 1 millisecond. In some embodiments, the time period can range from about 0.001 to about 10 seconds.

Without being limited by theory, it is understood that while a marine air gun has a primary pulse; it will produce series of secondary pulses that ring on for a relatively long period of time after the primary pulse. The secondary pulses are caused by the rapid expansion of the air in the water pushing the water out until its energy is equalized followed by the water collapsing back in which compresses the air bubble until it overcomes the pressure of equalization and then it expands again. This reverberation or bubble effect continues until the air bubble reaches the surface and is vented to the atmosphere. This bubble effect can be created when gas bubbles produced by an air gun oscillates and generates subsequent pulses that cause source-generated noise. Thus, total energy output of a marine air gun more closely resembles a long wavelet rather than an impulsive peak. The present invention recognizes that a combination of the wavelets can create vibroseis-like sweep despite using impulsive seismic sources. A description of vibroseis can be found in U.S. Pat. No. 2,989,726, the relevant parts of which are hereby incorporated by reference. This unique signal can be inverted or deconvolved out of a continuous seismic record and generate a shot record similar to a conventional air gun array. Techniques for inverting seismic signal are described in US20100208554, the relevant parts of which are hereby incorporated by reference.

An embodiment of the invention builds on the concept that the airgun actually produces a long signature of the initial pulse and the subsequent secondary pulses (bubble effect). The problem is how to de-tune the airgun array controllers to take advantage of this insight. For decades, the controller industry has worked to get the airguns to fire as accurately as possible so timing of under a millisecond is routinely available in the industry. Many feedback and predictive timing circuits are built into the new and modern controllers to force this precise timing to occur. The difficulty comes in trying to turn all of those features off in the controller and allow the end user to enter the delays necessary to allow unique coding of the composite pulse. It has been discover that older style controllers like the Real Time Systems “BigShot” allows users to override the default computer controlled delays and enter different delays so a composite pulse could be created. These delays have been varied from array to array thus creating uniqueness necessary for the inversion process to separate out the data from the composite record.

As an example of how the composite pulse would be created, consider an example array of three airguns of big, middle and small size. If as a demonstrative example we fired the port array and used the big gun first, then waited 200 ms and fired the middle gun and finally 125 ms later fired the small gun the composite pulse would have 3 smaller spikes and a long wave train of bubble interacting. If we flopped over to the starboard array and fired the middle gun, waited 90 ms, then fired the small gun, and finally waited 313 ms to fire the big gun the composite pulse would be distinctly different from the port array. These could then be separated from the continuously recorded seismic data via inversion or source signature deconvolution thus yielding a useable shot record for further processing.

### EXAMPLE

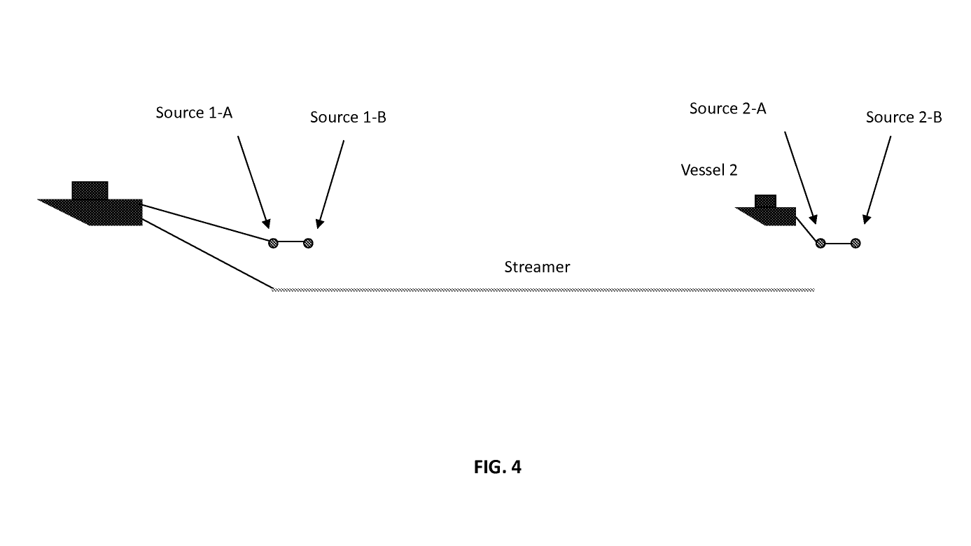

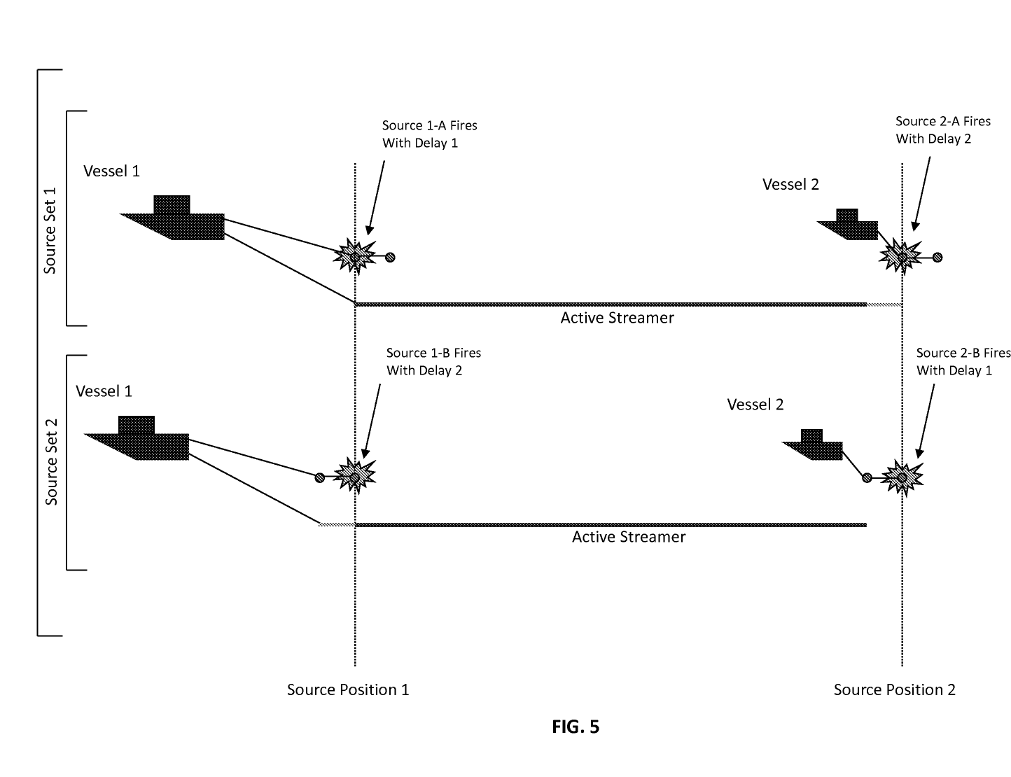

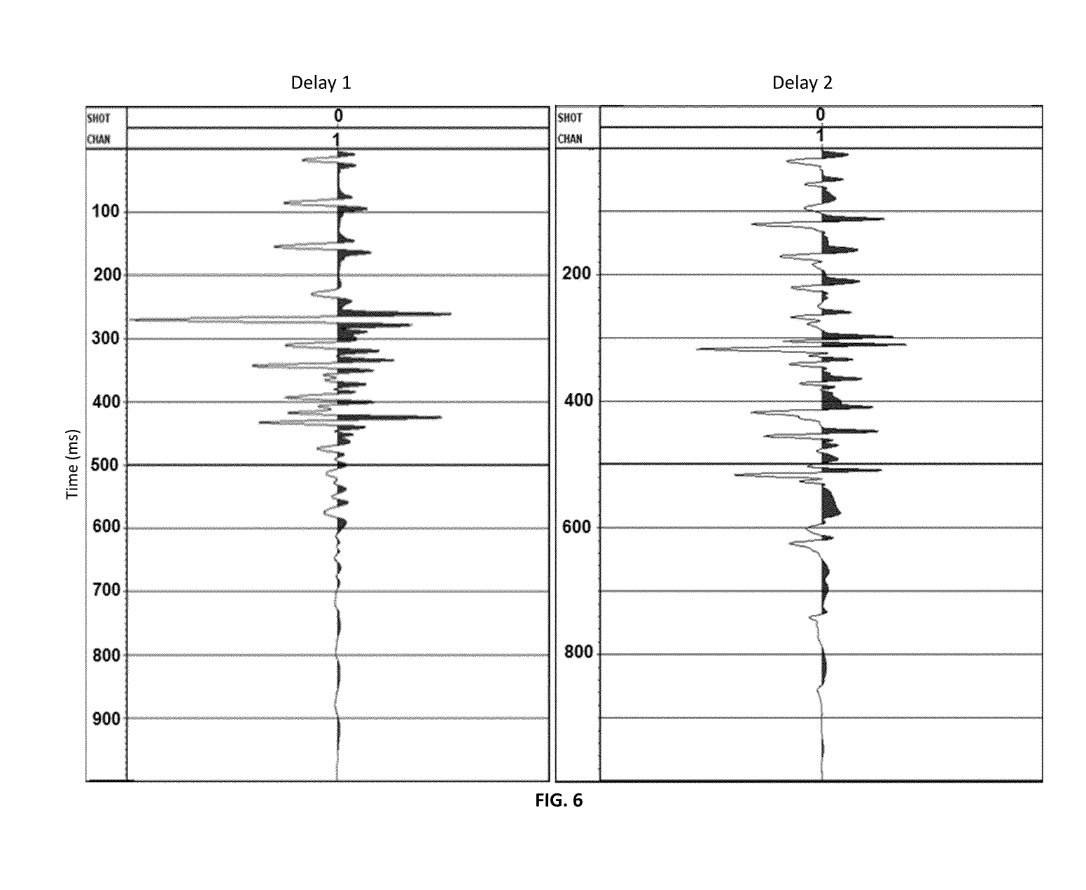

FIG. 4 illustrates a 2D streamer layout of two vessels (vessel 1 and vessel 2), each vessel having two sources (source 1-A and 1-B in vessel 1 and source 2-A and 2-B in vessel 2) and vessel 1 having a streamer. FIG. 5 shows simultaneous source sequence as represented in 2D. In the first source set, source 1-A and 2-A are fired simultaneously: source 1-A at source position 1 with delay signature 1 and source 2-A at source position 2 with delay signature 2. After the vessel sails forward, source set 2 in which source 1-B and 2-B fire simultaneously is employed: source 1-B at source position 1 with delay signature 2 and source 2-B at source position 2 with delay signature 1. This process can be repeated for next set of source positions. Data for each source position can be separated out using inversion technique. FIG. 6 shows delay signatures 1 and 2. These are examples of delay signatures that were created by varying the firing delay of the individual air-guns in an air-gun array. Unique delay patterns will create unique signatures.

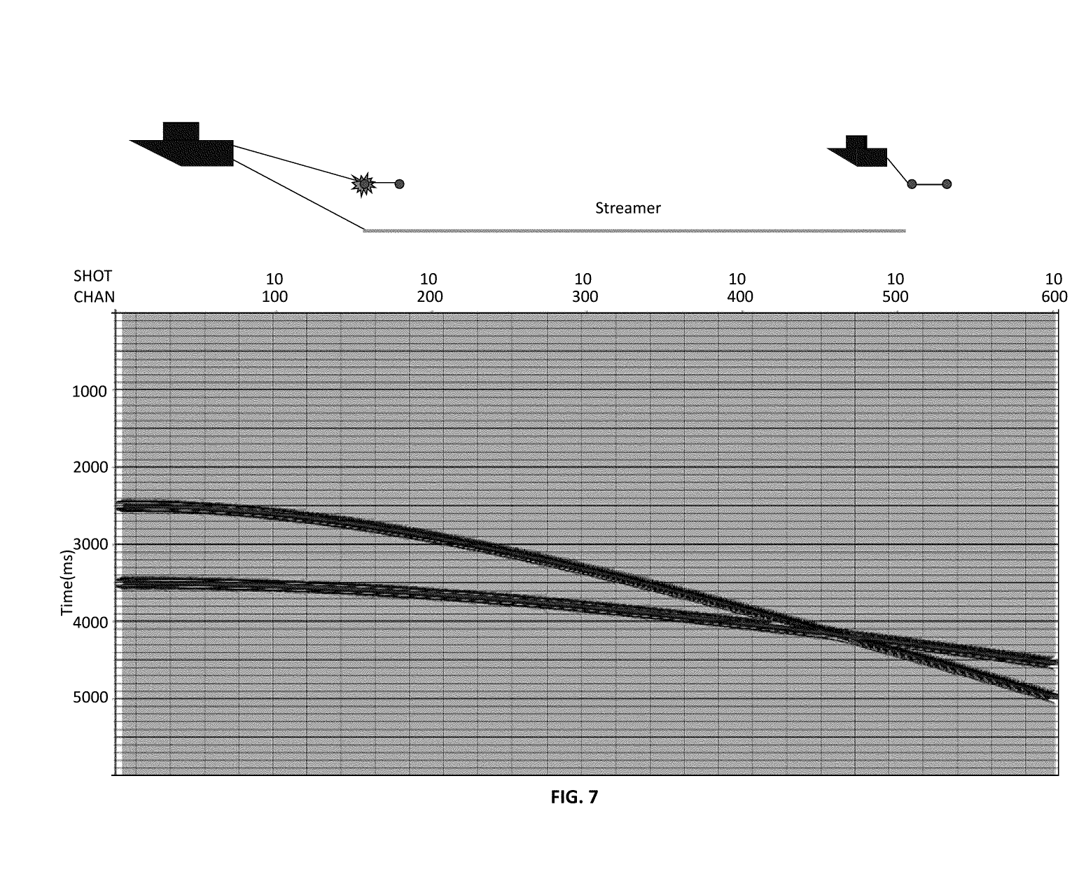

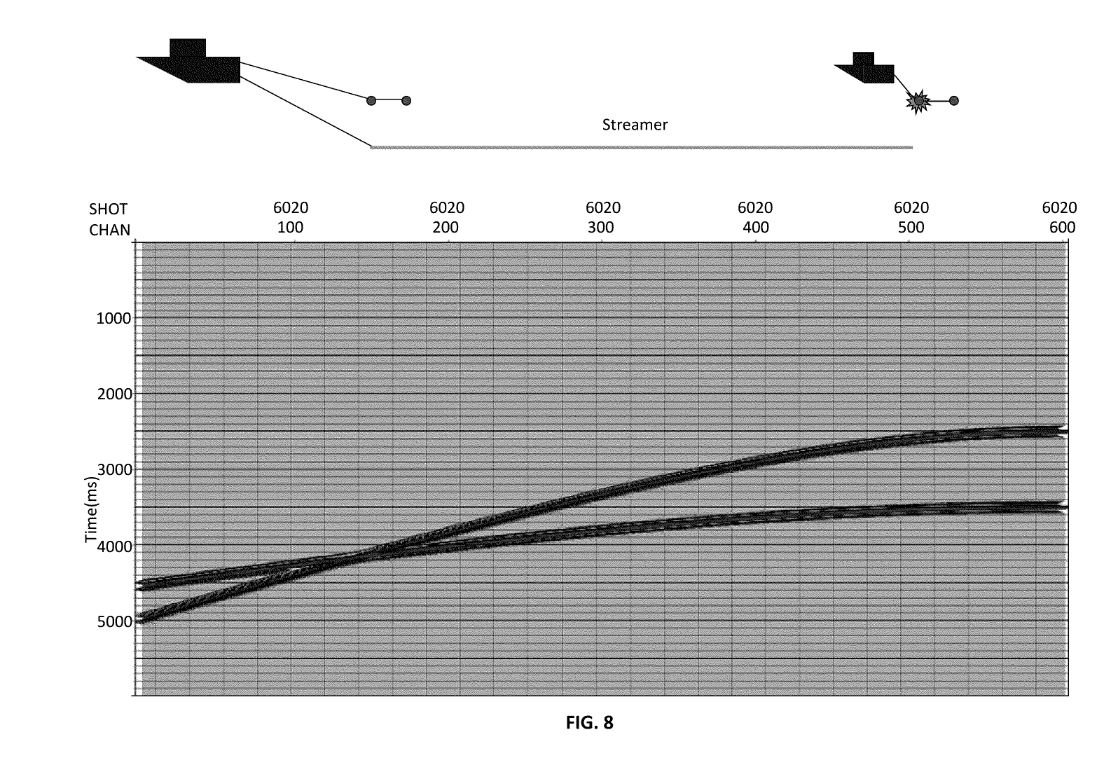

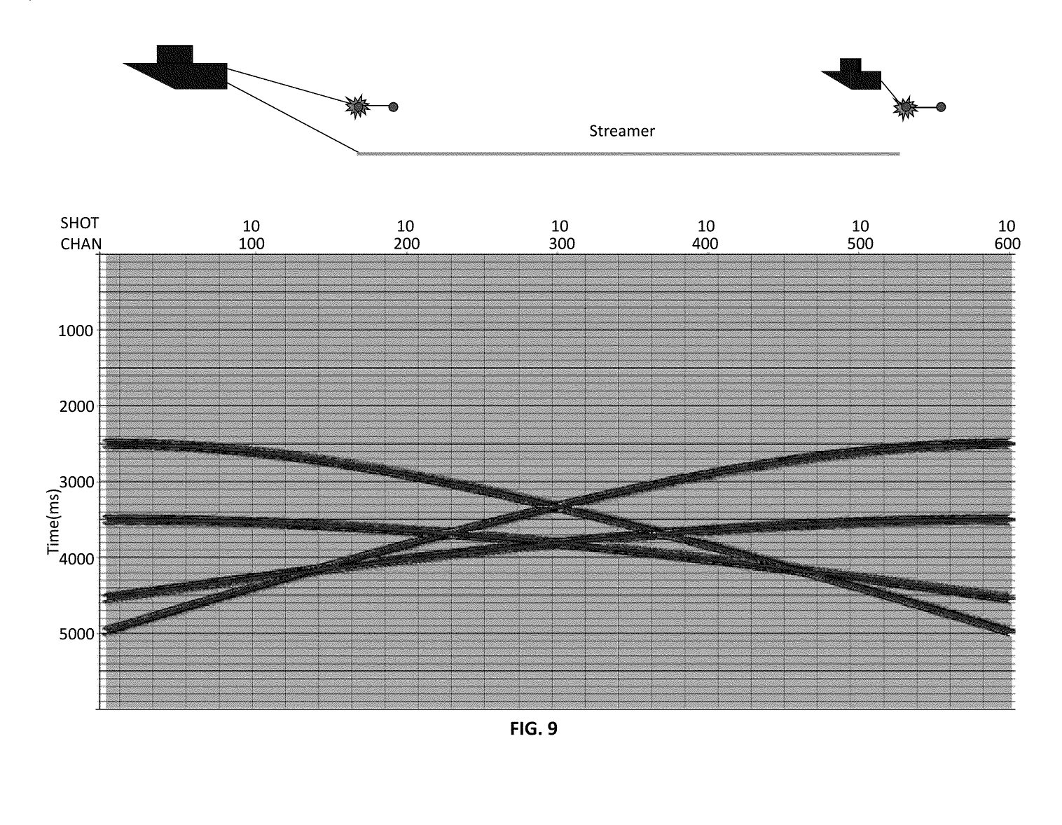

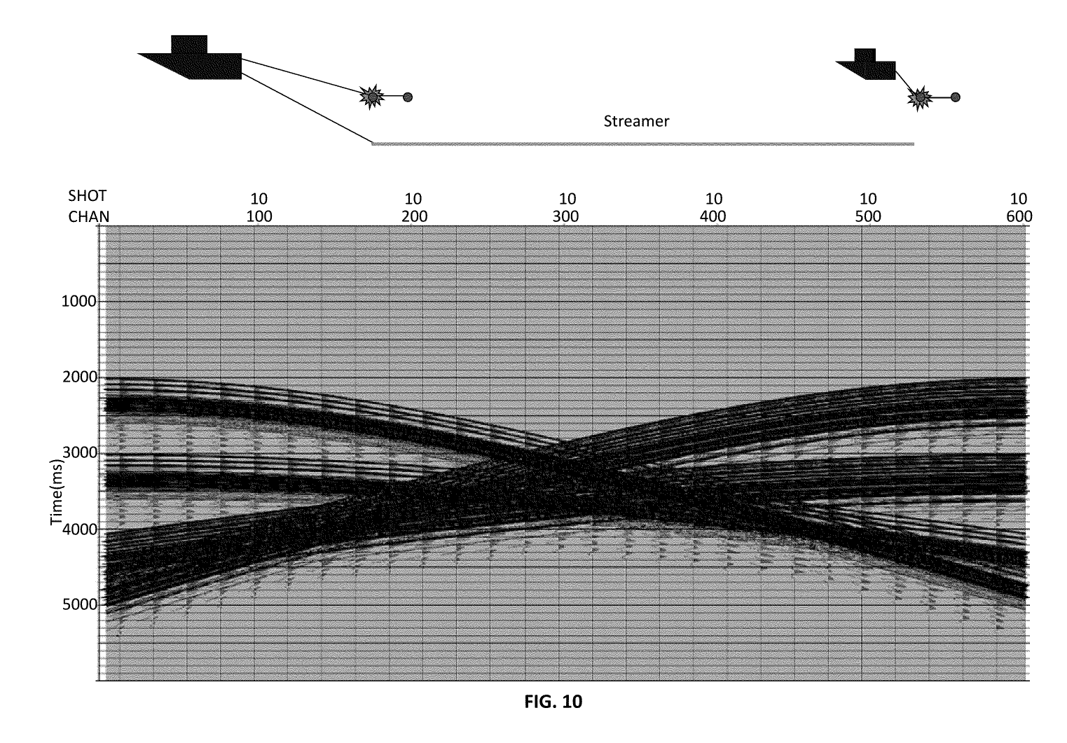

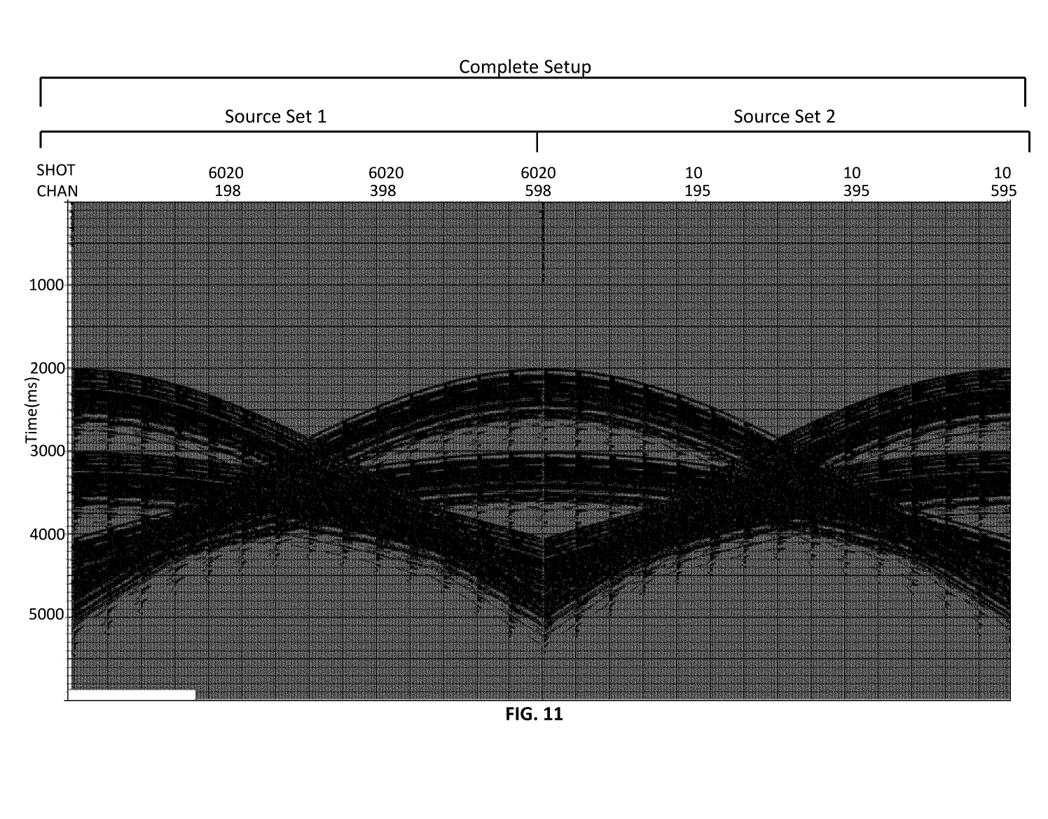

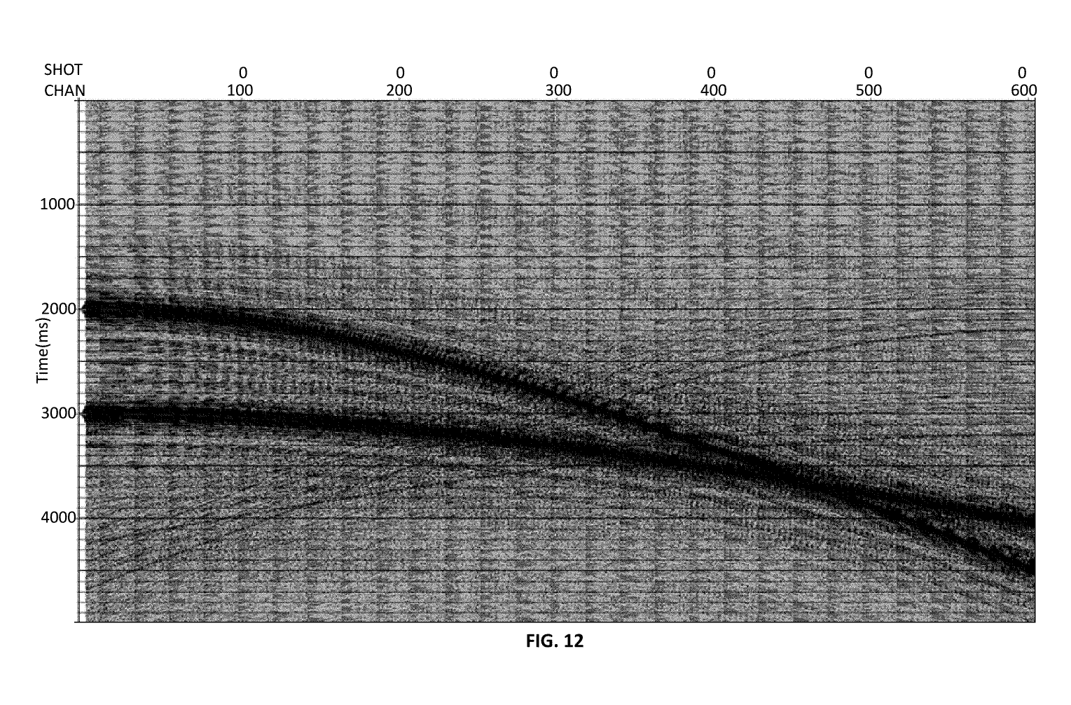

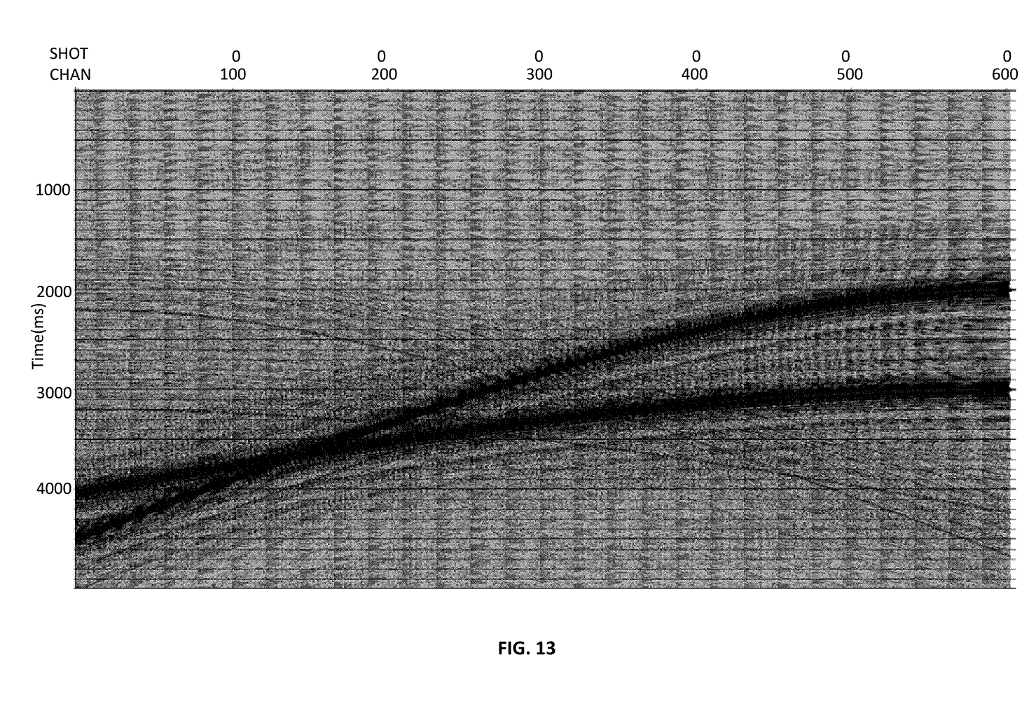

FIGS. 7-10 show data collected at different source positions. FIG. 7 corresponds to source position 1 (shown at top). FIG. 8 corresponds to source position 2. FIG. 9 corresponds to data from source positions 1 and 2 firing simultaneously. FIG. 10 corresponds to data from source positions 1 and 2 firing simultaneously with unique delay signatures. FIG. 11 shows field record for 1 complete setup including source sets 1 and 2. FIG. 12 shows field record for source position 1 after inversion. FIG. 13 shows field record for source position 2 after inversion.

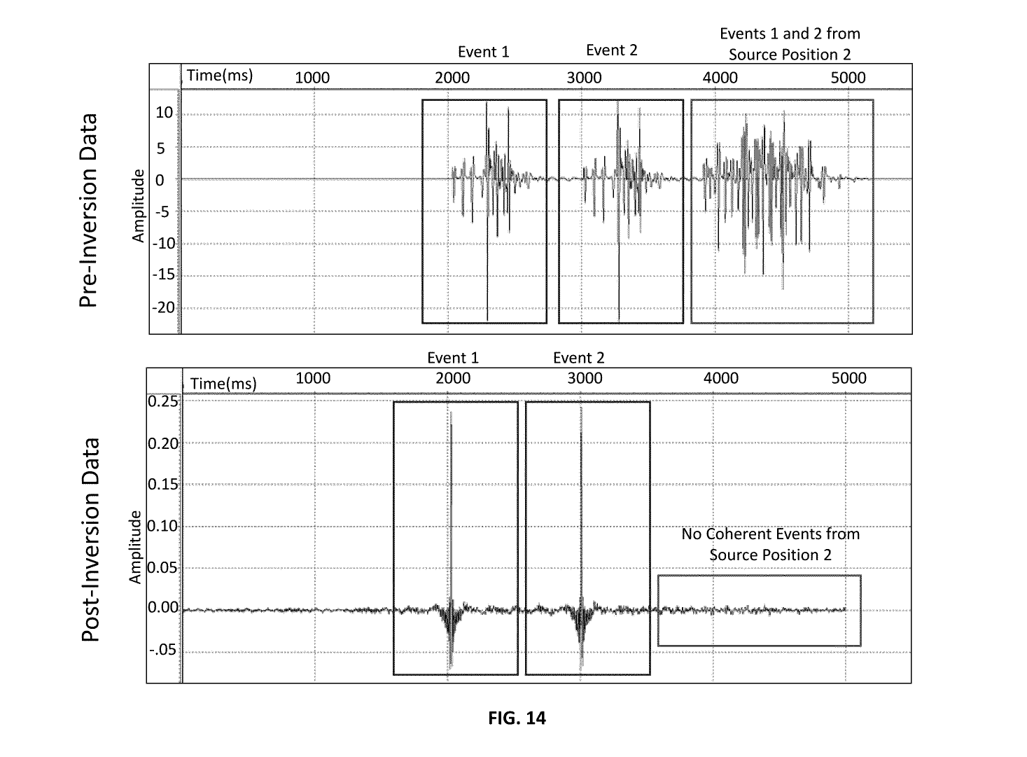

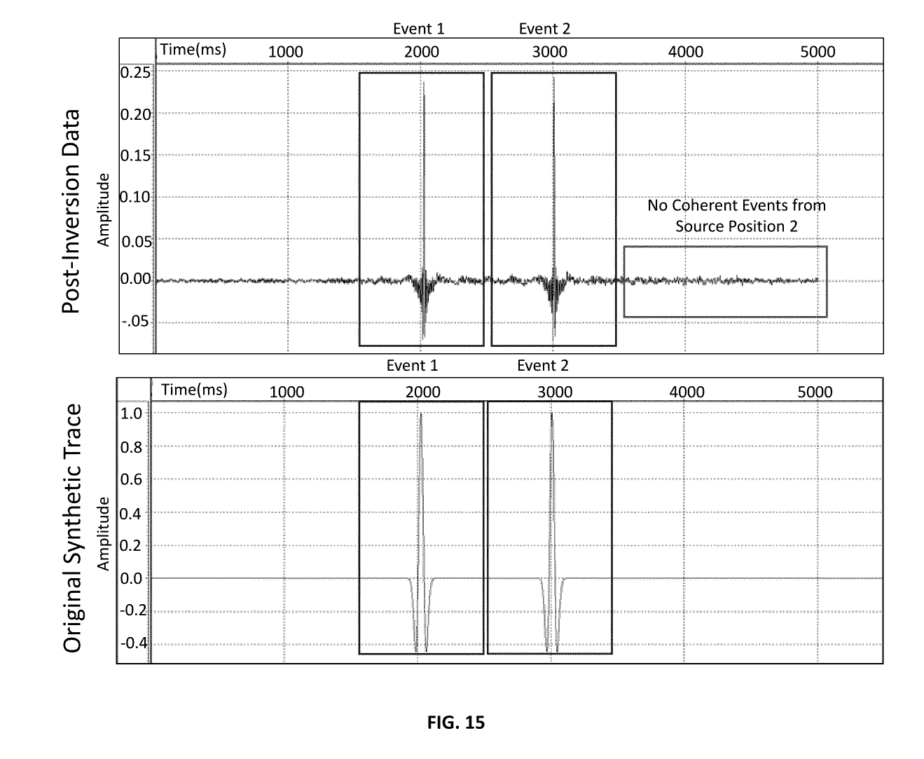

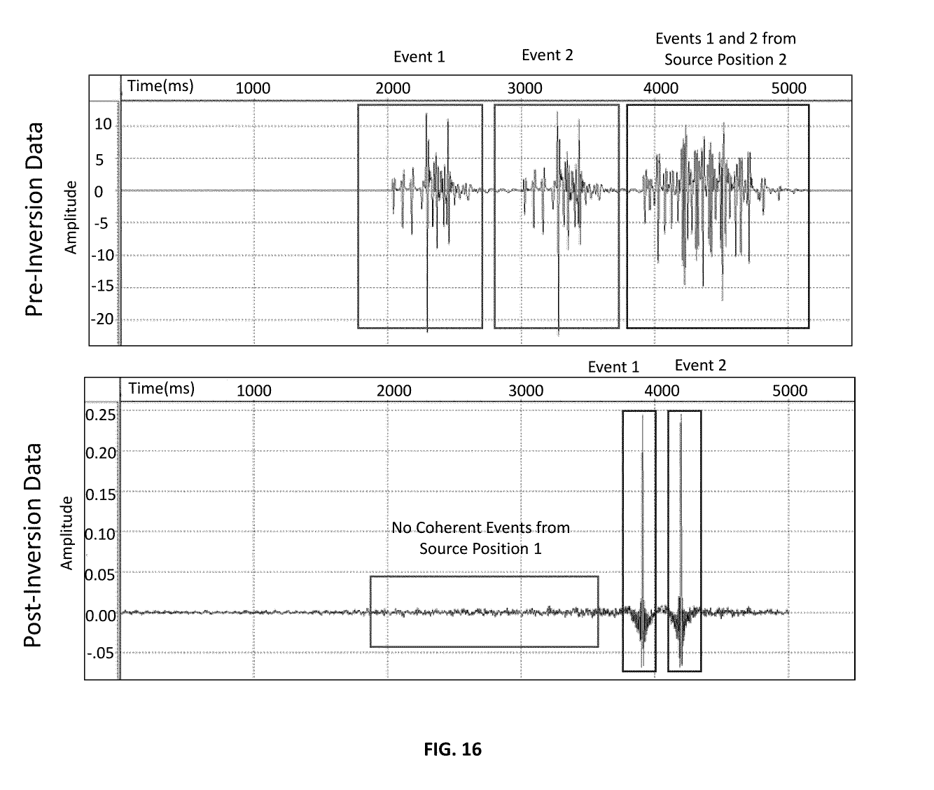

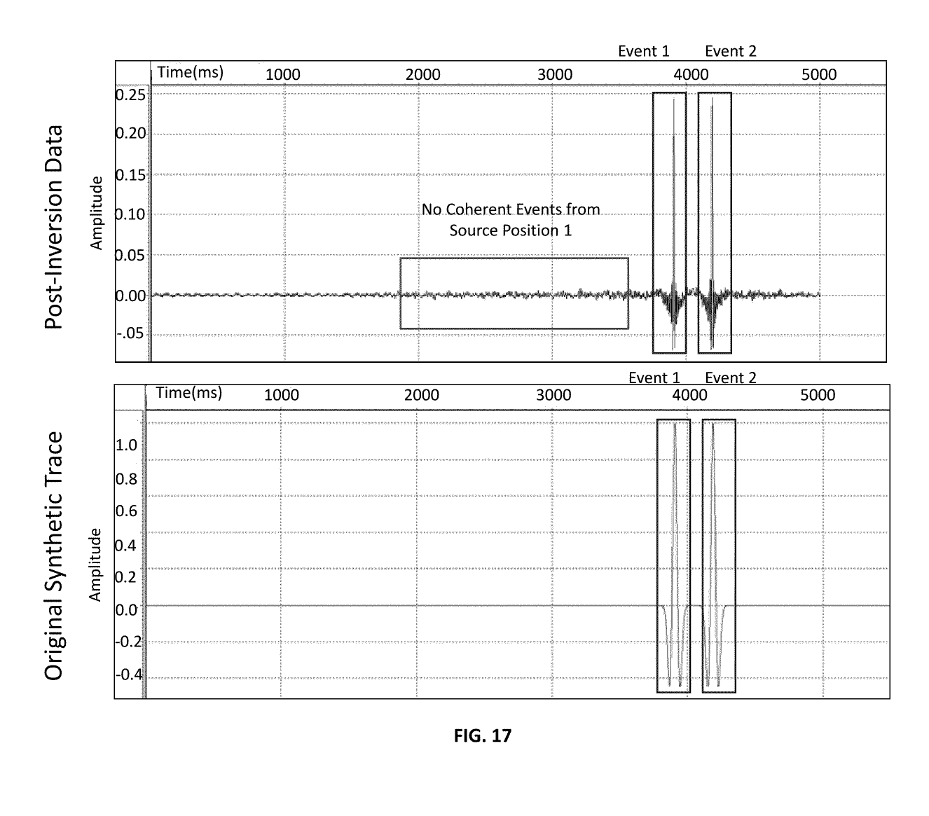

FIG. 14 illustrates single trace comparison at source position 1 before and after inversion. FIG. 15 illustrates single trace comparison at source position 1 after inversion versus original trace. FIG. 16 illustrates single trace comparison source position 2 before and after inversion. FIG. 17 illustrates single trace comparison at source position 2 after inversion versus original trace.

It should be obvious to those schooled in the art that given more than 3 guns, and more than just two arrays, with guns of different sizes very complex composite waveforms can be made. The advantage of this approach is that the peak energy output for the array is now significantly lower than if all the guns were fired at the same time. Also the composite pulse could be adjusted to achieve the maximum uniqueness for best reparability of the shot record during the inversion or source signature deconvolution. It should also be obvious to those schooled in the art that there is no intrinsic limitation that a particular airgun can fire only once during the shot like a normal array. The limit of use of the airguns becomes the air recharge rate and the desire for uniqueness of the source. It should also be obvious to those schooled in the art that this approach would allow multiple arrays to be fired from different vessels in close proximity with the potential of no or minimal interference and the conventional delays for listening periods are not necessary if the coding of the pulses is properly chosen between arrays.

The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of non-transitory computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), motive force (such as a translational force, propulsion force or a rotational force), magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

What is claimed is:

1. A method for acquiring seismic data comprising:
a) initiating firing of individual seismic sources at start of a shot point, wherein two or more of the plurality of seismic sources fire asynchronously in a selected sequence to generate a coded seismic signal;
b) collecting seismic data from the coded seismic signal;
c) inverting the seismic data; and
d) generating an output trace via computing device using the inverted seismic data.

2. The method of claim 1, wherein the seismic sources comprise air guns, plasma shots, or explosive shots.

3. The method of claim 1, wherein at least three or more seismic sources are fired asynchronously.

4. The method of claim 1, wherein the coded seismic signal is a pulse.

5. The method of claim 1, wherein the sequence comprises times at which the two or more seismic sources are shot and a time period between firing of the two or more seismic sources.

6. The method of claim 5, wherein time between firing of two seismic sources is between about 0.001 to about 10 seconds.

7. The method of claim 1, wherein the seismic data is collected using a plurality of seismic receivers.

8. A method for acquiring seismic data comprising:
a) arranging a plurality of seismic sources into an array of seismic sources;
b) firing the array of seismic sources, wherein at least two or more seismic sources are fired asynchronously in a selected sequence to generate a coded seismic signal;
c) collecting seismic data from the coded seismic signal using a plurality of seismic receivers;
d) inverting the seismic data; and
e) generating an output trace using the inverted seismic data.

9. The method of claim 8, wherein the seismic sources comprise air guns, plasma shots, or explosive shots.

10. The method of claim 8, wherein at least three or more seismic sources are fired asynchronously.

11. The method of claim 8, wherein the coded seismic signal is a pulse.

12. The method of claim 8, wherein the sequence comprises times at which the two or more seismic sources are shot and a time period between firing of the two or more seismic sources.

13. The method of claim 12, wherein time between firing of two seismic sources is between about 0.001 to about 10 seconds.

14. The method of claim 8, wherein the seismic data is collected using a plurality of seismic receivers.

15. A method for acquiring seismic data comprising:
a) arranging a plurality of seismic sources into an array of seismic sources;
b) initiating firing of the array of seismic sources, wherein at least two or more seismic sources are fired asynchronously in a selected sequence to generate a pulse signal;
c) collecting seismic data using a plurality of seismic receivers;
d) inverting the seismic data; and
e) generating an output trace using the inverted seismic data.

16. The method of claim 15, wherein the seismic sources comprise air guns.

17. The method of claim 15, wherein at least three or more seismic sources are fired asynchronously.

18. The method of claim 15, wherein the sequence comprises times at which the two or more seismic sources are shot and a time period between firing of the two or more seismic sources.

19. The method of claim 18, wherein time between firing of two seismic sources is between about 0.001 to about 10 seconds.

20. The method of claim 15, wherein the seismic data is collected using a plurality of seismic receivers.
